(19) United States
(12) Patent Application Publication
(10) Pub. No.: US 2008/0113188 A1
(43) Pub. Date: May 15, 2008

(54) HYDROPHOBIC ORGANIC-INORGANIC HYBRID SILANE COATINGS

(76) Inventors: Pratik B. Shah, Christiansburg, VA (US); Jeffrey C. Brinker, Albuquerque, NM (US); Bryan E. Koene, Blacksburg, VA (US)

Correspondence Address: MH2 TECHNOLOGY LAW GROUP, LLP, 1951 KIDWELL DRIVE, SUITE 550, TYSONS CORNER, VA, 22182, US

(21) Appl. No.: 11/934,238

(22) Filed: Nov. 2, 2007

Related U.S. Application Data
(60) Provisional application No. 60/857,845, filed on Nov. 9, 2006.

(51) Int. Cl. B32B 27/28; C08G 77/12

(52) U.S. Cl. 428/336; 427/240; 427/387; 427/427.4; 427/430.1; 428/447; 528/31

(57) ABSTRACT

Exemplary embodiments provide compositions and devices for hydrophobic coatings, and methods for making them. The hydrophobic coating can be formed from a coating solution including, for example, organically modified silicates (ormosils) mixed with coupling agents. Specifically, a sol-gel solution can be formed (e.g., at room temperature) including a plurality of alkoxy silane precursors that contains at least one glycidoxy alkoxy silane precursor. In an exemplary embodiment, the sol-gel solution can be a mixed sol-gel solution formed including a first solution mixed with a second solution. The first solution can include one or more alkoxy silane precursors, and the second solution can include at least one glycidoxy alkoxy silane precursor. A coupling agent can then be added and reacted (e.g., cross-linked) with the (mixed) sol-gel solution forming the coating solution, which can be applied onto a substrate that needs to be protected from corrosion or from chemical and/or biological agents.

### RELATED APPLICATIONS

This application claims priority from U.S. Provisional Patent Application Ser. No. 60/857,845, filed Nov. 9, 2006, which is hereby incorporated by reference in its entirety.

### FIELD OF THE INVENTION

This invention relates generally to protective coatings and, more particularly, to hydrophobic organic-inorganic hybrid silane coatings.

### BACKGROUND OF THE INVENTION

In recent years, the total defense related corrosion costs has been estimated to be more than about 7% of the total annual U.S. cost with 20% of the estimated corrosion-related costs involving scraping and repainting steel structures. Because of the staggering costs stemming from corrosion of steel infrastructure, there is a tremendous need to develop multifunctional coatings that can outperform traditional coatings. For example, the production of water-repelling hydrophobic surfaces has huge opportunities in the area of corrosion inhibition for metal components, and also in the area of chemical, and biological agent protection for clothing, and many other applications.

Many different approaches have been tried for achieving corrosion resistant materials. For example, a two-layer-coating can be formed on a metal component to make corrosion resistant material. The two-layer-coating can include a hydrophobic bottom layer and a hydrophobic (or ultra-/super-hydrophobic) top layer used to prevent water and/or salt ions from penetrating through the surface. Problems arise, however, due to high porosity and/or fractal geometry of the bottom layer and/or the top layer, pitting and other small corrosion can be generated by water vapor, especially on long runs.

Thus, there is a need to overcome these and other problems of the prior art and to provide robust and inexpensive hydrophobic coatings that can be coated on a large area substrate and can be sufficiently dense for use as a first line of defense.

### SUMMARY OF THE INVENTION

According to various embodiments, the present teachings include a hydrophobic coating composite. The hydrophobic coating composite can include a sol-gel solution having a plurality of alkoxy silane precursors that includes at least one glycidoxy alkoxy silane precursor. The hydrophobic coating composite can further include a coupling agent mixed with the sol-gel solution for a cross-linking reaction.

According to various embodiments, the present teachings also include a method for preparing a hydrophobic coating. In this method, a plurality of alkoxy silane precursor solutions can be formed for a sol-gel process, wherein at least one of the plurality of precursor solutions includes a glycidoxy alkoxy silane precursor. The plurality of alkoxy silane precursor solutions can then be mixed to form a sol-gel solution, followed by adding a coupling agent to the sol-gel solution to form a coating solution. The coating solution can then be applied to a substrate surface providing a hydrophobic coating.

According to various embodiments, the present teachings further include a hydrophobic device. The hydrophobic device can include a substrate component, and one or more hydrophobic coatings formed on the substrate component by applying a coating solution. The coating solution can further include a coupling agent mixed with a sol-gel solution that includes a plurality of alkoxy silane precursors having at least one glycidoxy alkoxy silane precursor.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 depicts an exemplary method for forming a hydrophobic coating in accordance with the present teachings.

FIG. 2 depicts an exemplary coating process on a substrate component in accordance with the present teachings.

FIG. 3 depicts an exemplary coating process to heal the damaged body of a substrate component in accordance with the present teachings.

FIG. 4 depicts an exemplary corrosion inhibitor in accordance with the present teachings.

FIG. 5 depicts an exemplary substrate healing device in accordance with the present teachings.

### DESCRIPTION OF THE EMBODIMENTS

Reference will now be made in detail to the present embodiments (exemplary embodiments) of the invention, examples of which are illustrated in the accompanying drawings. Wherever possible, the same reference numbers will be used throughout the drawings to refer to the same or like parts. In the following description, reference is made to the accompanying drawings that form a part thereof, and in which is shown by way of illustration specific exemplary embodiments in which the invention may be practiced. These embodiments are described in sufficient detail to enable those skilled in the art to practice the invention and it is to be understood that other embodiments may be utilized and that changes may be made without departing from the scope of the invention. The following description is, therefore, merely exemplary.

While the invention has been illustrated with respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.” The term “at least one of” is used to mean one or more of the listed items can be selected.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less that 10” can assume negative values, e.g. −1, −2, −3, −10, −20, −30, etc.

Exemplary embodiments provide compositions and devices for hydrophobic coatings, and methods for making them. The hydrophobic coating can be formed from a coating solution including, for example, organically modified silicates (ormosils) that are formed through the hydrolysis and condensation reactions of organically modified silanes, as well as a mix with coupling agents. Specifically, a sol-gel solution can be formed (e.g., at room temperature) including a plurality of alkoxy silane precursors that contains at least one glycidoxy alkoxy silane precursor. In an exemplary embodiment, the sol-gel solution can be a mixed sol-gel solution formed including a first solution mixed with a second solution. The first solution can include one or more alkoxy silane precursors, and the second solution can include at least one glycidoxy alkoxy silane precursor. A coupling agent can then be added and reacted (e.g., cross-linked) with the (mixed) sol-gel solution forming the coating solution, which can be applied onto a substrate that needs to be protected from corrosion or from chemical and/or biological agents.

As used herein, the terms “hydrophobic” and “hydrophobicity” refer to the wettability of a surface (e.g., a coating surface) that has a water contact angle of approximately 85° or more. Typically, on a hydrophobic surface, for example, a 2-mm-diameter water drop beads up but does not run off the surface when the surface is tilted moderately. As the surface is tilted, the wetting angle at the downhill side of the droplet increases, while the wetting angle at the uphill side of the droplet decreases. Since the advancing (downhill) interface has a hard time pushing forward onto the next increment of solid surface, and the receding (uphill) interface has a hard time letting go of its bit of solid surface, the droplet tends to remain stationary or pinned in place. A hydrophobic surface is described as having a large hysteresis between advancing and receding contact angles (typically 20 degrees or more).

The sol-gel process is a solution-based method for making silica gel. In the sol-gel process, a suitable precursor or combination of precursors can be hydrolyzed to generate a solid state polymeric silicon-oxygen network. The initial hydrolysis of the precursor(s) generates a liquid solution (i.e., sol) that ultimately becomes a gel. The sol-gel process can therefore be considered as including the following stages or steps: forming a sol-gel solution, gelation (i.e., polymerization), and drying.

As disclosed herein, the sol-gel solution can include a plurality of alkoxy silane precursors that contain at least one epoxysilane precursor. Each alkoxy silane precursor or a combination of precursors can be modified with at least one organic group (i.e., at least one of the alkoxy groups is replaced by an organic group), that results in a hybrid inorganic-organic sol-gel precursor or organic-inorganic siloxane that is used to form an organically modified silicate. In addition, the at least one epoxysilane precursor can include, for example, glycidoxy alkoxy silane.

In various embodiments, the sol-gel solution can be a mixed sol-gel solution formed by preparing and mixing a plurality of precursor solutions. Each of the plurality of precursor solutions can include an alkoxy silane precursor or a combination of precursors. In addition, at least one of the plurality of precursor solutions can include a precursor of glycidoxy alkoxy silane. Because the sol-gel process forms a gel from a solution using a molecular precursor, the sol-gel process can be designed at the molecular level by an appropriate selection of the modifying organic functional group(s), which allows for considerable control over the properties (e.g., hydrophobicity and/or density/porosity) of the final coating.

The alkoxy silane precursors can be organically modified silane monomers having a general formula of, for example, (R′)ₓSi(OR)₄₋ₓ, wherein x is 1 or 2. The glycidoxy alkoxy silane can be a glycidoxy-group-containing alkoxy silane having a general formula of, for example, (E-R′)Si(OR)₃, wherein E is a group containing the glycidoxy group. In the foregoing formulas for both the general alkoxy silane and the glycidoxy-group-containing alkoxy silane, R and R′ can be the same or different and can include an organic group, such as, for example, an alkyl, an alkenyl, an alkynyl, an aryl group, or combinations thereof.

In one example, for R and R′ in the general formulas referenced above, the term “alkyl” is meant to have its art-recognized meaning. Substituted and unsubstituted, as well as branched and unbranched C₁- through C₂₀-alkyls can be contemplated, including methyl-, ethyl-, propyl-, isopropyl-, n-propyl- and butyl-. Exemplary substituents can include —OH and —OR″, wherein R″ is a C₁₋₄ alkyl.

In another example, for R and R′ in the general formulas referenced above, the term “alkenyl” is meant to have its art-recognized meaning. Substituted and unsubstituted, as well as branched and unbranched C₂- through C₂₀-alkenyls having at least one double bond at varying location(s) are contemplated, including vinyl-, allyl- and isopropenyl-. Exemplary substituents include —OH and —OR″, wherein R″ is a C₁₋₄ alkyl.

In an additional example, for R and R′ in the general formulas referenced above, the term “alkynyl” is meant to have its art-recognized meaning. Substituted and unsubstituted, as well as branched and unbranched C₂- through C₂₀-alkynyls having at least one triple bond at varying locations are particularly contemplated, including ethynyl-, propynyl-, and butynyl-. Exemplary substituents include —OH and —OR″, wherein R″ is a C₁₋₄ alkyl.

In a further example, for R and R′ in the general formulas referenced above, the term “aryl” is meant to have its art-recognized meaning. Substituted, unsubstituted, and multiple ring aryl groups are contemplated, including benzyl-, ethylbenzyl-, phenyl-, xylene substituents, toluene, sytrene and naphthalene substituents.

During the sol-gel process, the gelation or polymerization stage is of particular interest and that can be described as a two-step reaction including hydrolysis of an organically modified silicate precursor followed by condensation of the hydrolyzed precursor. The initiation of the polymerization reaction is typically performed via a hydrolysis of alkoxide groups to form hydroxylated —Si—OH groups. An example of this hydrolysis is set forth in the following equation:

(R′)_{X}Si(OR)_{4-X}+H₂O→[R′Si(OR)_{4-X-1}OH]+ROH (1)

Propagation then occurs by the polycondensation of these hydroxylated species giving rise to silane-oxygen polymers. That is, the polycondensation can lead to the formation of OSiO bridges and the removal of XOH species as indicated in the following equation:

—SiOH+SiOX→—SiOSi—+XOH (2)

Where X is hydrogen or organic groups. At this stage, the single-phase liquid becomes a two-phase gel including a —Si—O—Si— network (solid phase) with an interstitial liquid phase.

In this manner, each precursor solution can be first reacted (i.e., hydrolysis and/or condensation) separately and then mixed together to form the mixed sol-gel solution. The mixed sol-gel solution can be stored in a refrigerator (e.g., at about −20° C. to about 5° C.) for a length of time that can be as short as a few hours and as long as a few days, or can be directly used to prepare the coating solution.

The coating solution can further include a coupling agent, in addition to the mixed sol-gel solution. The coupling agent can be a cross-linking agent that reacts with the mixed sol-gel solution. Therefore, the coating properties, for example, hydrophobicity, density, surface structure, bonding strength to a substrate, etc., can be affected by the selection of each precursor, for example, the modifying organic functional groups (i.e., R, and R′ in the above referenced formulas), as well as the coupling agent.

The selection of the precursor or a combination of precursors can be based on the desired degree of hydrophobicity of the coating. In general, it is desirable to maximize the hydrophobicity of the coating by selecting a precursor that forms a coating surface with the highest degree of intrinsic hydrophobicity. In an exemplary embodiment, precursors having monovalent alkyl groups can be used to provide a high hydrophobicity of the coating surface. In addition, the selection of a precursor or combination of precursors can be based on various other factors including density, ease of application, and cost. For example, as with hydrophobicity, density (or porosity) can be tailored by selecting the R′ group of the precursor to control the interaction between the generally hydrophilic silicate groups and the generally hydrophobic organic R′ groups. The more hydrophobic for the R′ groups, the denser for the hydrophobic coating. This is because the generally hydrophobic R′ groups tend to be repelled by the hydrophilic —Si-O-Si groups and tend to minimize their free energy by aggregating with each other and thus to form dense coatings. In another example, by selecting a suitable precursor or combination of precursors, all the solutions used during the sol-gel process can be formed and/or mixed at room temperature for ease of application unless specified otherwise.

The selection of coupling agent can be based on the cross-linking reaction with the mixed and hydrolyzed plurality of precursor solutions to improve the adhesion of the hydrophobic coating to a desired surface. For example, the coupling agent can be desirable to contain amino group(s). The inclusion of an amino group can be of benefit, for example, in the applications related to metallic and purely organic polymer (e.g., polyethylene or polypropylene) surfaces, because amino groups can be included to enhance the bonding interactions. Exemplary coupling agents can include, but are not limited to, pyridine, imidazole, and/or methylimidazole.

As the hydrolysis and/or condensation reactions continue, the viscosity of the coating solution increases (and the solution eventually ceases to flow). The viscous coating solution can be applied to any substrate/article that needs to be protected from corrosion and/or chemical/biological agents. For example, the viscous coating solution can be applied to a wide variety of materials, including metals including aluminum, silicon or any metal alloy, silicon wafers, glass, ceramics, plastics, and fabrics using various coating techniques. As used herein, the term “coating technique” refers to a technique or a process for applying, forming, or depositing the coating solution on a substrate or for forming sol-gel monoliths. Therefore, the term “coating technique” is not particularly limited, and dip coating, painting, brush coating, roller coating, pad application, spray coating, spin coating, casting, or flow coating can be employed. In an exemplary embodiment, the hydrophobic coating solution can have a viscosity that is suitable for coating on a large area in the depot or in the field. For example, the coating solution having sufficient viscosity can be sprayed onto a large surface of an aviation structure. In various embodiments, the hydrophobic sol-gel coatings can be formed by a single layer or multiple layers using suitable coating techniques.

After the coating solution is coated on the substrate, a drying process can be performed at a temperature of, for example, about 30° C. to about 200° C., for a time length of about 30 minutes to about 120 minutes. In an exemplary embodiment, the coated substrate can be dried at 200° C. for about 30 minutes. Regardless of the manner in which the coating is formed, each dried coating can have a thickness of about 0.3 to about 3 μm.

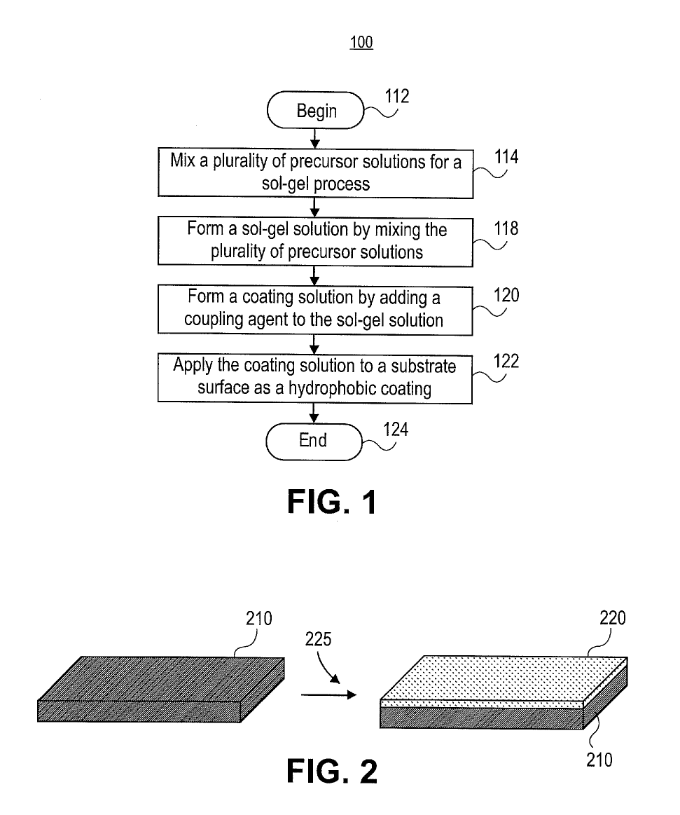

FIG. 1 depicts an exemplary method 100 for preparing a hydrophobic coating in accordance with the present teachings. While the exemplary method 100 is illustrated and described below as a series of acts or events, it will be appreciated that the present invention is not limited by the illustrated ordering of such acts or events. For example, some acts may occur in different orders and/or concurrently with other acts or events apart from those illustrated and/or described herein, in accordance with the present teachings. In addition, not all illustrated steps may be required to implement a methodology in accordance with the present teachings.

Beginning at 112 of the method 100, the hydrophobic coating can be formed from a coating solution that includes a mixed sol-gel solution and a coupling agent. The mixed sol-gel solution can further include a plurality precursor solutions at 114, wherein each precursor solution can include one or more alkoxy silane precursors and at least one precursor solution can include a glycidoxy alkoxy silane precursor or a combination with other alkoxy silane precursors. For example, a mixed sol-gel solution can include a first solution mixed with a second solution at room temperature. The first solution can include one or more alkoxy silane precursors selected from the group consisting of the general formula of (R′)ₓSi(OR)₄₋ₓ, (wherein x is 1 or 2), including, for example, methyltrimethoxy silane (MTMS), vinyltrimethoxy silane, dimethyidiethoxy silane, methacryloxypropyltrimethoxy silane, mercaptopropyltrimethoxy silane, chloropropyltrimethoxy silane, bromopropyltrimethoxy silane, iodopropyltrimethoxy silane, chloromethyltrimethoxy silane, tetraethoxysilane, tetramethoxysilane, 1,2-bis(triethoxysilyl) ethane, or mixtures thereof. The second solution can include one or more precursors that contain a glycidoxy alkoxy silane selected from the group consisting of the general formula of (E-R′)Si(OR)₃ (where E is a group containing glycidoxy group), including, for example, 3-(glycidoxypropyl)trimethoxysilane (GLYMO), 3-(glycidoxypropyl)dimethyle-thoxysilane, 3-(glycidoxypropyl)triethoxysilane, 4-(glycidoxybutyl)trimethoxysilane, 3-(glycidoxypropyl)meth- yidimethoxysilane, or combinations thereof.

Still at 114, each precursor solution can undergo a hydrolysis process using a catalyst. The hydrolysis reaction can usually be conducted by adding water and a catalyst for hydrolysis to the alkoxy silane precursor, followed by a stirring process. This hydrolysis can be carried out in the presence of an alcohol such as ethanol or isopropyl alcohol. The catalyst for hydrolysis can include an acid catalyst or a base catalyst. The acid catalyst can be any acid catalyst known to be a hydrolysis catalyst without any particular restriction. For example, an inorganic acid such as hydrochloric acid, nitric acid or sulfuric acid, or an organic acid such as acetic acid or p-toluenesulfonic acid can be mentioned. In an exemplary embodiment, an inorganic acid such as hydrochloric acid can be used. By hydrolysis of the hydrolyzable alkoxy silane compound, a silanol group can be formed. In a usual case, a condensation reaction due to the formed silanol group can be likely to take place at the same time.

When preparing each precursor solution, the alkoxy silane or combinations of alkoxy silanes can be mixed with, for example, a catalyst such as hydrochloric acid, an alcohol such as an ethanol, and water with certain ratios to conduct the hydrolysis reaction and the condensation reaction. This certain ratio can be determined by the organic groups (e.g., R in the above referenced formulas) on the selected silane compound precursors. For example, the plurality of precursor solutions can include the first precursor solution and the second precursor solution, wherein the first precursor solution can be a mixture of MTMS silanel hydrochloric acid catalyst/ethanol/deionized water with a corresponding molar ratio of, for example, about 1/1/6/2, and the second precursor solution can be a mixture of GLYMO silane /hydrochloric acid catalyst/ethanol/deionized water with a corresponding molar ratio of, for example, about 0.5/1/6/2. Each precursor solution can be formed by a further stirring, for example, for about 1 hour at room temperature.

At 118, the plurality of the hydrolyzed and stirred precursor solutions can be mixed with one another to form a mixed sol-gel solution. The mixing can be performed having a molar ratio between the selected alkoxy silane precursors of the mixed sol-gel solution. For example, in the embodiment that includes the first solution having MTMS precursor and the second solution having GLYMO precursor, the mixing can include a corresponding GLYMO molar fraction of from about 1 to 100 parts, such as 50 parts, over the total 100 parts of the mixed precursors (i.e., the mixture of GLYMO and MTMS) by mole. Following the mixing, the sol-gel solution can be stirred for about 1 hour at room temperature. In various embodiments, the sol-gel solution can be formed and hydrolyzed by mixing a plurality of precursors (e.g., MTMS and GLYMO) in a solution containing catalyst, alcohol, deionized water with a certain molar ratio. For example, the sol-gel solution can include a mix of MTMS/GLYMO/hydrochloric acid catalyst/ethanol/deionized water having a corresponding molar ratio of, for example, about 1/0.5/2/12/4.

At 120, a coating solution can be formed by adding a coupling agent to the (mixed) sol-gel solution. The coupling agent can be a cross-linking agent to cross-link species of the mixed and hydrolyzed plurality of precursor solutions. For example, the coupling agent can be methylimidazole (MI), which can react with the epoxy (i.e., glycidoxy) group from the GLYMO precursor and provide an adhesive property to “glue” the hydrophobic coating with a substrate surface. The amount of the coupling agent can be suitably from 1 to 100 parts per 100 parts by mole of the epoxysilane in the mixed sol-gel solution. For example, the amount of the MI coupling agent can be about 69 parts by mole per 100 parts of GLYMO precursor in the above referenced example where the mixed sol-gel solution includes the first precursor solution of MTMS and the second precursor solution of GLYMO.

The coating solution, including the mixed sol-gel solution and the coupling agent, can then be stirred at room temperature for about 30 minutes, for example. In various embodiments, the coating solution can be filtered to remove possible undesired impurities prior to the subsequent coating process. For example, before coating, the coating solution can be filtered using a glass membrane that having a desired pore size of such as about 0.45 μm to remove any particles with a diameter that is more than 0.45 μm.

At 122, the coating solution can be coated onto a substrate surface by means of a “coating technique” to readily form a uniform hydrophobic film/coating. For example, a dip coating can be carried out utilizing a motorized dip coating apparatus to dip the substrate surface into the prepared coating solution and then to withdraw the dipped substrate at various desired withdrawal speeds, such as about 5 IPM (inch per min). In various embodiments, the substrate surface can be cleaned prior to any coating process, for example, by rinsing with ethanol and a cleaning with dry nitrogen gas. The cleaned surface can then be used to form a hydrophobic coating thereon.

After the coating process, a drying process can be applied to the coated substrate having a temperature of, e.g., about 200° C., with a length of time, e.g. about 30 minutes, in order to remove residual alcohol and complete the curing process of the coating solution. In various embodiments the dried hydrophobic coating can have a thickness of about 0.3 to about 3 μm. As shown, the method 100 concludes at 124.

Table 1 shows exemplary results including thickness, refractive index, and contact angle (with water) for various coated hydrophobic films formed generally according to the method 100 of FIG. 1. In this example, the hydrophobic film can be coated on a cleaned silicon wafer with various coating speeds of about 2, 5, and 10 IPM. The exemplary coated films can be heated to dry at about 200° C. for about 30 minutes.

TABLE 1

| | | Coating | Thickness | Refractive | Contact |
|---|---|---|---|---|---|
| No. | Formulation | Speed (IPM) | (angstrom) | index | angle (°) |
| 1 | MTMS- | 2 | 3652.5 | 1.4304 | 85-87 |
| 2 | GLYMO | 5 | 5243 | 1.4258 | 85-90 |
| 3 | | 10 | 9084.8 | 1.4362 | 85-87 |

As shown in table 1, the resulting hydrophobic film on an exemplary silicon wafer can have a high contact angle with water of about 85° or higher, that means a highly hydrophobic surface. The highly hydrophobic coating surface can provide an increased corrosion protection (e.g., on a large area applied in depot or in field) and/or self-healing capabilities (e.g., a quick fix in the field) for the underlying substrate surfaces.

FIG. 2 is a schematic showing an exemplary coating process on a substrate component in accordance with the present teachings. As shown, a substrate component 210 can be provided requiring a large area protection from corrosion or chemical/biological agents. For example, the substrate component 210 can be a metal structure, for example, an aluminum structure of an aircraft.

In FIG. 2, A hydrophobic coating 220 can be formed on the substrate component 210 from a disclosed coating solution 225 that includes a coupling agent and a mixed sol-gel solution formed at room temperature. The coating solution 225 can have a viscosity that is suitable for, for example, being sprayed onto the large area of the substrate component 210. In addition, the formed hydrophobic coating 220 can be a dense coating, for example, having a sufficiently low porosity or being non-porous.

In various embodiments, the dense hydrophobic coating 220 can have an increased anti-corrosion property. For example, experimental results (not shown) indicate that a dense hydrophobic coating formed on a metal aluminum structure depicts no corrosion occurred for about 1800 hours or longer. Such experiments can be conducted utilizing a standard Salt Fog Corrosion Testing system that is in accordance with “Standard Procedure for Operating Salt Spray (Fog) Apparatus” (ASTM B 117).

In various embodiments, multiple hydrophobic coating 220 can be formed on the substrate component 210 for a thick wear. In addition, the hydrophobic coating 220 can be transparent that does not affect color of the underlying substrate component 210.

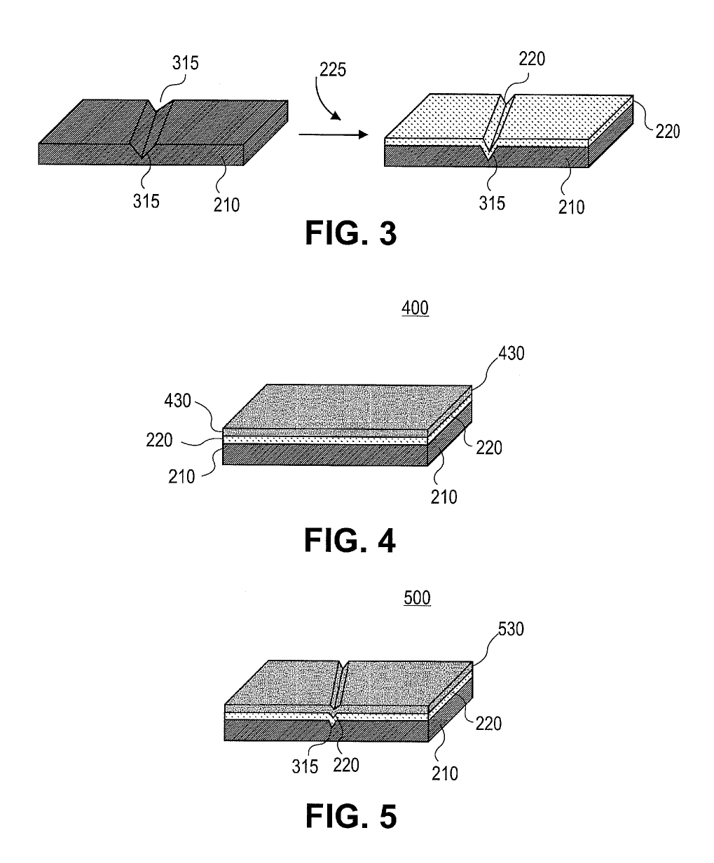

In various embodiments, the disclosed hydrophobic coating (e.g., the hydrophobic coating 220) can be employed to provide self-healing property for a damaged substrate. For example, FIG. 3 is a schematic depicting an exemplary coating process of a hydrophobic coating 220 formed to heal a damaged. area 315 in the body of a substrate component 210 in accordance with the present teachings. As shown, the hydrophobic coating 220 can be coated onto the substrate component 210 including surfaces of the damaged area 315, which is present in the body of the substrate component 210, for example, with bare metal substrate exposed. In an exemplary embodiment, the damaged area 315, such as a scratch and its impacted areas, can be examined after the coating process of the hydrophobic coating 220 according to “Standard Test Method for Evaluation of Painted or Coated Specimens Subjected to Corrosive Environment” (ASTM D 1654). It is discovered that no corrosion can be observed at the exemplary damaged area 315 due to the self-healing capability of the hydrophobic coating 220. In addition, hydrophobic coating 220 can be transparent that does not affect color of the underlying substrate component 210.

In various embodiments, the disclosed hydrophobic coating/film (e.g., the hydrophobic coating 220 in FIGS. 2-3) can be used as a dense barrier layer near the vicinity of a substrate surface and having a top coating formed thereon to make a corrosion inhibitor and/or a substrate healing device.

FIG. 4 depicts an exemplary corrosion inhibitor device 400 based on the coating process shown in FIG. 2 in accordance with the present teachings. As shown in FIG. 4, a top layer 430 can be formed over the hydrophobic coating 220 of FIG. 2 forming the corrosion inhibitor device 400. It should be readily apparent to one of ordinary skill in the art that the device 400 depicted in FIG. 4 represents a generalized schematic illustration and that other layers can be added or existing layers can be removed or modified.

The top layer 430 can be one of a hydrophobic, an ultra-hydrophobic or a super-hydrophobic layer as known to one of ordinary skill in the art to prevent liquid (e.g., water), and salt ions from penetrating inside onto the substrate component 210. In various embodiments, a plurality of hydrophobic coating 220 can be formed between the substrate component 210 and the top layer 430 of the device 400.

FIG. 5 depicts an exemplary substrate healing device 500 based on the coating process shown in FIG. 3 in accordance with the present teachings. As shown in FIG. 5, a top layer 530 can be formed over the hydrophobic coating 220 formed on surfaces of the substrate component 210 including the damaged area 315 of FIG. 3, forming the substrate healing device 500. It should be readily apparent to one of ordinary skill in the art that the device 500 depicted in FIG. 5 represents a generalized schematic illustration and that other layers can be added or existing layers can be removed or modified.

Likewise, the top layer 530 can be one of a hydrophobic, an ultra-hydrophobic or a super-hydrophobic layer as known to one of ordinary skill in the art to prevent liquid (e.g., water) and salt ions from penetrating inside onto the substrate component 210 including the damaged area 315. In various embodiments, a plurality of hydrophobic coating 220 can be formed between the substrate component 210 and the top layer 530 of the device 500.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A hydrophobic coating composite comprising:
a sol-gel solution comprises a plurality of alkoxy silane precursors that comprise at least one glycidoxy alkoxy silane precursor; and
a coupling agent mixed with the sol-gel solution for a cross-linking reaction.

2. The composite of claim 1, wherein the sol-gel solution is a mixed sol-gel solution comprising a first solution mixed with a second solution, wherein the first solution comprises one or more alkoxy silane precursors, and the second solution comprises at least one glycidoxy alkoxy silane precursor.

3. The composite of claim 1, wherein the plurality of alkoxy silane precursors are selected from the group consisting of a general formula of (R′)Si(OR)₃ or (R′)₂Si(OR)₂, wherein R and R′ are the same or different and are organic groups that comprise between 1 and 20 carbon atoms in the organic group chains.

4. The composite of claim 1, wherein the at least one glycidoxy alkoxy silane precursor is selected from the group consisting of a general formula of (E-R′)Si(OR)₃, wherein E is a functional group comprising a glycidoxy group; and R and R′ are the same or different and are organic groups that comprise between 1 and 20 carbon atoms in the organic group chains.

5. The composite of claim 1, wherein the coupling agent comprises a cross linking agent selected from the group consisting of pyridine, imidazole, and methyl imidazole.

6. A method for preparing a hydrophobic coating comprising:
forming a plurality of alkoxy silane precursor solutions for a sol-gel process, wherein at least one of the plurality of precursor solutions comprises a glycidoxy alkoxy silane precursor;
forming a sol-gel solution by mixing the plurality of alkoxy silane precursor solutions;
adding a coupling agent to the sol-gel solution forming a coating solution; and
applying the coating solution to a substrate surface forming a hydrophobic coating.

7. The method of claim 6, further comprising filtering the coating solution prior to the application to the substrate surface, wherein the filtering comprises flowing the coating solution through a membrane having a pore size of about 0.45 μm.

8. The method of claim 6, further comprising a drying process following the application of the coating solution to the substrate surface.

9. The method of claim 6, further comprising a room temperature stirring process following one or more steps of the formation of the plurality of alkoxy silane precursor solutions, the formation of the sol-gel solution, and the formation of the coating solution.

10. The method of claim 6, wherein the alkoxy silane precursor comprises one or more silane compounds selected from the group consisting of methyltrimethoxy silane, vinyltrimethoxy silane, dimethyldiethoxy silane, methacryloxypropyltrimethoxy silane, mercaptopropyltrimethoxy silane, chloropropyltrimethoxy silane, bromopropyltrimethoxy silane, iodopropyltrimethoxy silane, and chloromethyltrimethoxy silane, tetraethoxysilane, tetramethoxysilane, and 1,2-bis(triethoxysilyl) ethane.

11. The method of claim 6, wherein the at least one glycidoxy alkoxy silane precursor comprises a silane compound selected from the group consisting of 3-(glycidoxypropyl)trimethoxysilane, 3-(glycidoxypropyl)dimethylethoxysilane, 3-(glycidoxypropyl)triethoxysilane, 4-(g lycidoxybutyl)trimethoxysilane and 3-(glycidoxypropyl)methyldimethoxysilane.

12. The method of claim 6, wherein applying the coating solution to the substrate surface comprises a technique selected from the group consisting of dip coating, brush coating, roller coating, spray coating, spin coating, casting, and flow coating.

13. The method of claim 6, further comprising applying the coating solution on a large area of the substrate surface in depot or in field.

14. The method of claim 6, wherein the coating solution has a sufficient viscosity for forming a dense hydrophobic coating on the substrate surface.

15. The method of claim 6, wherein the substrate surface comprises a material selected from the group consisting of metal, silicon wafers, glass, ceramics, plastics, and fabrics.

16. The method of claim 6, further comprising,
forming a sol-gel solution at room temperature by mixing a first solution comprising methyltrimethoxy silane (MTMS) with a second solution comprising 3-(glycidoxypropyl)trimethoxysilane (GLYMO),
forming a coating solution by adding a cross linking agent to the sol-gel solution, wherein the cross linking agent comprises 1-methylimidazole that has a certain molar ratio with GLYMO, and
forming a hydrophobic coating by applying the coating solution onto a substrate surface.

17. The method of claim 16, further comprising a room temperature stirring process to one or more of the first solution, the second solution, the sol-gel solution, and the coating solution.

18. A hydrophobic device comprising:
a substrate component; and
one or more hydrophobic coatings formed on the substrate component by applying a coating solution, wherein the coating solution comprises a coupling agent mixed with a sol-gel solution comprising a plurality of alkoxy silane precursors that comprise at least one glycidoxy alkoxy silane precursor.

19. The hydrophobic device of claim 18, wherein each of the one or more hydrophobic coatings is sufficiently dense or non-porous.

20. The hydrophobic device of claim 18, wherein each of the one or more hydrophobic coatings has a thickness of about 0.3 to about 3 μm.

21. The hydrophobic device of claim 18, wherein each of the one or more hydrophobic coatings resists corrosion for about 1800 hours or longer.

22. A corrosion inhibitor comprising a top layer on the one or more hydrophobic coatings on the substrate component according to claim 18, wherein the top layer prevents water and salt ions from penetrating there through.

23. The hydrophobic device of claim 18, wherein the substrate component comprises a damaged area with the one or more hydrophobic coatings formed thereon.

24. A substrate healing device comprising a top layer on the one or more hydrophobic coatings according to claim 23, wherein the top layer prevents water and salt ions from penetrating there through.
